(19) United States
(12) Patent Application Publication
(10) Pub. No.: US 2008/0105814 A1
(43) Pub. Date: May 8, 2008

(54) BASE-PLATE ADAPTER

(76) Inventor: STEPHEN O. SLATTER, Naples, FL (US)

Correspondence Address: ROBERT M. SCHWARTZ, P.A., P.O. BOX 221470, HOLLYWOOD, FL, 33022, US

(21) Appl. No.: 11/931,642

(22) Filed: Oct. 31, 2007

Related U.S. Application Data
(60) Provisional application No. 60/855,622, filed on Oct. 31, 2006.

(51) Int. Cl. F16M 13/00

(52) U.S. Cl. 248/521

(57) ABSTRACT

The present invention is a base plate adapter in combination with an outrigger assembly and a hardtop assembly having a hardtop with a hole formed therein for receiving the outrigger assembly and a mounting plate on an underside of the hardtop. The mounting plate has a hole corresponding to the hole in the hardtop. The outrigger assembly has a sealing tube disposed above the hardtop and a rotator assembly disposed below the hardtop. The base plate adapter mounts the outrigger assembly to the hardtop assembly. The base plate adapter includes a configuration for attaching the base plate adapter to the outrigger assembly. A diameter configured for passing through the hole formed in the hardtop, the diameter defining a shoulder having a surface configured for mating with the mounting plate. The shoulder has threaded holes formed therein configured for receiving threaded fasteners passing through the mounting plate, thereby securing the outrigger assembly to the mounting plate.

### INDEX TO RELATED APPLICATIONS

This application claims the benefit of U.S. Provisional Patent Application Ser. No. 60/855,622, filed Oct. 21, 2006, entitled Base Plate Adapter and Supporting Mounting Plate, the prior application is herewith incorporated by reference in its entirety.

### FIELD OF THE INVENTION

This invention relates to the field of sport fishing and particularly to an outrigger mounting system having a base-plate adapter featuring an integral method of attachment directly through a thick fiberglass hardtop section to a relative flat or angled mounting plate or hollow extruded aluminum profile support mounting plate.

The present invention pertains to a base plate adapter that permits mounting of an outrigger assembly to a supporting framework or structure of a marine vessel. More specifically, to a base plate adapter that permits mounting of an outrigger assembly to a hardtop assembly.

### BACKGROUND OF THE INVENTION

Typically outrigger base mounts are utilized on the top and sides of saltwater sport fishing vessels for the purpose of supporting outriggers whether of the fixed or telescopic outrigger types for the purpose of trolling wide distances with fishing lines and bait supported and deployed by long outrigger booms.

Popularity has grown in the last several years with the avid use of bolt-in style outrigger base mounts versus weld-in outrigger base mounts providing greater flexibility to both boat builders and the end user/purchaser. This gives a user the option to add at a later date a bolt-in outrigger base mount.

The present invention addresses several mounting problems and tower application issues associated with bolt-in style mounts that have rectangular or non-round lower base plates that are used to mount the outrigger base mounts on thick fiberglass hardtops.

Outrigger base mounts of the bolt-in style type are typically secured to an aluminum flat mounting plate or hollow extruded aluminum profile that is already pre-welded into a tower framework using a flat rectangular or square shaped base-plate that is part of the outrigger base mount and of which typically has at least four fasteners that would be used to secure it to the vessel tower framework support mounting plate from the top side.

Typically a canvas covered T-Top type of tower structure would have a canvas cover sandwiched between the outrigger base mount (a rectangular base-plate) and the tower support mounting plate. In some cases a sealant is used to prevent saltwater from leaking through to the underside of the T-Top. The sealant is placed between the top side of the canvas material and the bottom side of the outrigger base mount (a flat rectangular base-plate) in order to seal out water and prevent dripping down below.

Increasingly popular are fiberglass constructed hardtop types of sport-fishing vessels. The hardtop is typically about 2 inches thick. Typically four drilled holes are made in the 2 inch thick hardtop section to secure the bolt-in outrigger base mounts. In most instances spacers have to be used to prevent crushing of the Fiberglass constructed hardtop material. Also, in this arrangement the outrigger base-mount often becomes loose over time.

Some hardtops also utilize an additional reinforcing aluminum tower plate or extrusion profile that is placed underneath the fiberglass hardtop so that the four fasteners can also be secured into threaded holes of the tower mounting plate or bolted to the tower's support mounting plate.

A fiberglass hardtop without an already installed tower plate below it sometimes uses a 5 inch×6 inch backing plate to reinforce the installation of the bolt-on outrigger base-mount in conjunction with spacers for the securing fasteners to reinforce the fiberglass hardtop material to prevent crushing of the fiberglass hardtop section.

Generally, bolt-in outrigger base-mounts on the market have rectangular or square shaped base-plates and typically have a minimum of four holes pre-drilled in the base-plates for fastening the outrigger base-mount to the top of a sport-fishing vessel whether it be a T-Top canvas or fiberglass hardtop construction style top.

Both types of tower designs typically have a central hole of at least 3 inches in diameter to allow the lower portion of the bolt-in outrigger base-mount to pass through the canvas or hardtop style constructed tower types.

Both of the above tower types often have a curved or sloped design. The fabricator then has to use plastic or aluminum wedge-spacers which are placed underneath the flat rectangular/square base-plate of the outrigger base-mounts, to keep the bolt-in style mount in the preferable vertical position when fully bolted down to the curved/sloped tops. The wedge-spacer is typically tapered by design, anywhere from three (3) to eleven (11) degrees of slope, in the port to starboard plane—depending on the requirements of tower manufacturer—so as to counteract the curvature or slope of the T-Top or hardtop tower design types that it is being mounted to.

The fasteners used to secure the bolt-in mounts in this case would typically also pass through the wedge-spacer to fully secure the wedge spacer that is sandwiched between the bolt-in outrigger base mount rectangular/square base-plate and the support mounting plate or hardtop.

An additional problem with some curved fiberglass hardtop applications is that existing flat bottomed base-plates of the outrigger base mounts do not secure down flat, if mounting directly to the top side of the some curved fiberglass hardtop, so special glues are used to fill the gaps or distortion of the rectangular/square base-plates of the outrigger base-mounts (or the fiberglass hardtops) when fully tightening the fasteners.

### SUMMARY OF THE INVENTION

It is accordingly an object of the invention to provide an base plate adapter, which overcomes the above-mentioned disadvantages of the heretofore-known devices of this general type and which provides a bas plate adapter that is more versatile and easier to use.

With the foregoing and other objects in view there is provided, in combination with an outrigger assembly and a hardtop assembly having a hardtop with a hole formed therein for receiving the outrigger assembly and a mounting plate on an underside of the hardtop. The mounting plate has a hole corresponding to the hole in the hardtop. The outrigger assembly has a sealing tube disposed above the hardtop and a rotator assembly disposed below the hardtop, a base plate adapter. The base plate adapter mounts the outrigger assembly to the hardtop assembly. The base plate adapter includes a configuration for attaching the base plate adapter to the outrigger assembly. A diameter configured for passing through the hole formed in the hardtop, the diameter defining a shoulder having a surface configured for mating with the mounting plate. The shoulder has threaded holes formed therein configured for receiving threaded fasteners passing through the mounting plate, thereby securing the outrigger assembly to the mounting plate.

In accordance with another feature of the invention, the surface has angle which compliments an angle of the mounting plate for aligning the outrigger assembly in a vertical position.

In accordance with an added feature of the invention, locating pins are disposed at the surface, the locating pins providing a radial location of the base plate adapter.

In accordance with an additional feature of the invention, a seal is configured to seal a gap between the sealing tube and the hardtop.

In accordance with yet an additional feature of the invention, the configuration includes counterbored holes for fastening the base plate adapter to the outrigger assembly.

Other features which are considered as characteristic for the invention are set forth in the appended claims.

Although the invention is illustrated and described herein as embodied as a base plate adapter for mounting an outrigger assembly to a hardtop assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1a is a perspective partial section view of the outrigger assembly, hardtop assembly and the base plate adapter according to the invention;

FIG. 1b is a section view of the outrigger assembly, hardtop assembly and the base plate adapter according to the invention;

FIG. 2 is an exploded perspective view of the outrigger assembly, hardtop assembly and the base plate adapter according to the invention;

FIG. 3 is a perspective view of the outrigger assembly, hardtop assembly and the base plate adapter according to the invention;

FIG. 4 shows several views of the base plate adapter according to the invention; and

FIG. 5 is a perspective view of the underside of the mounting plate of the hardtop assembly.

### DESCRIPTION OF THE PREFERRED EMBODIMENTS

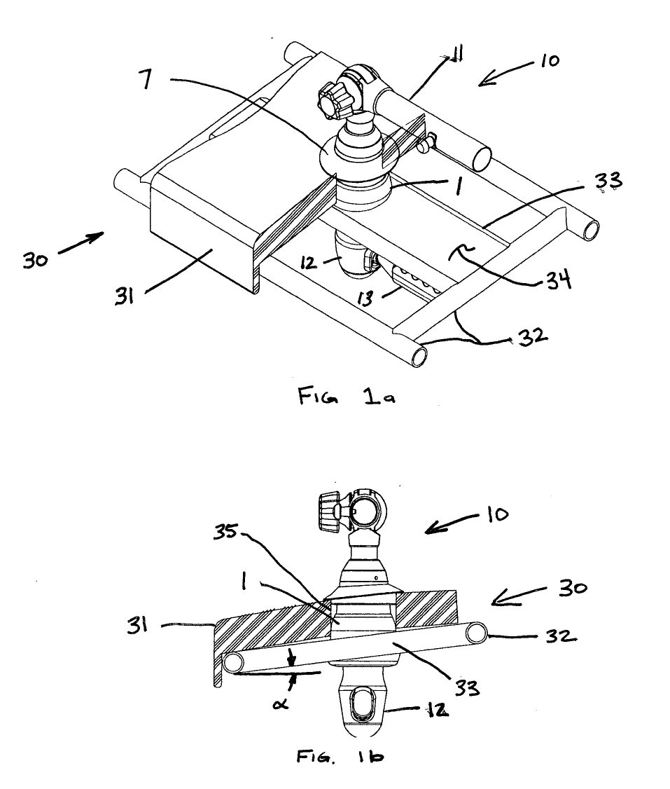

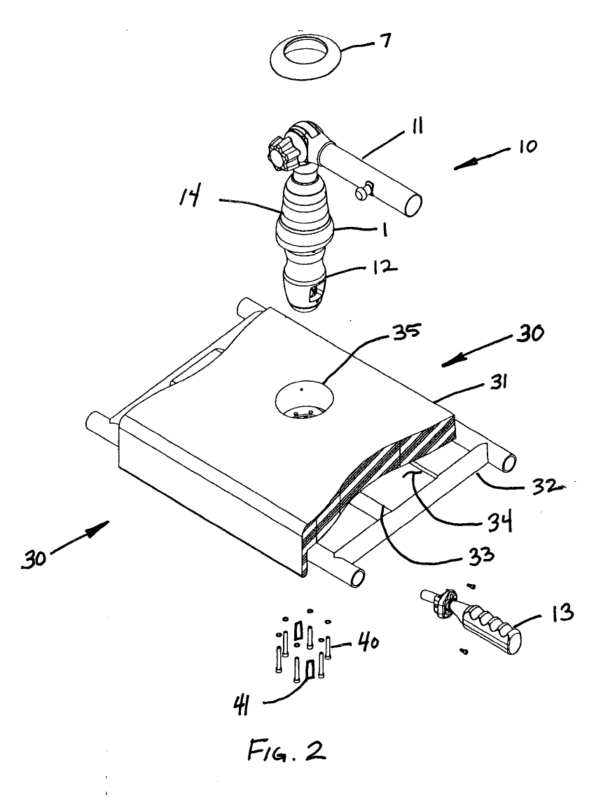

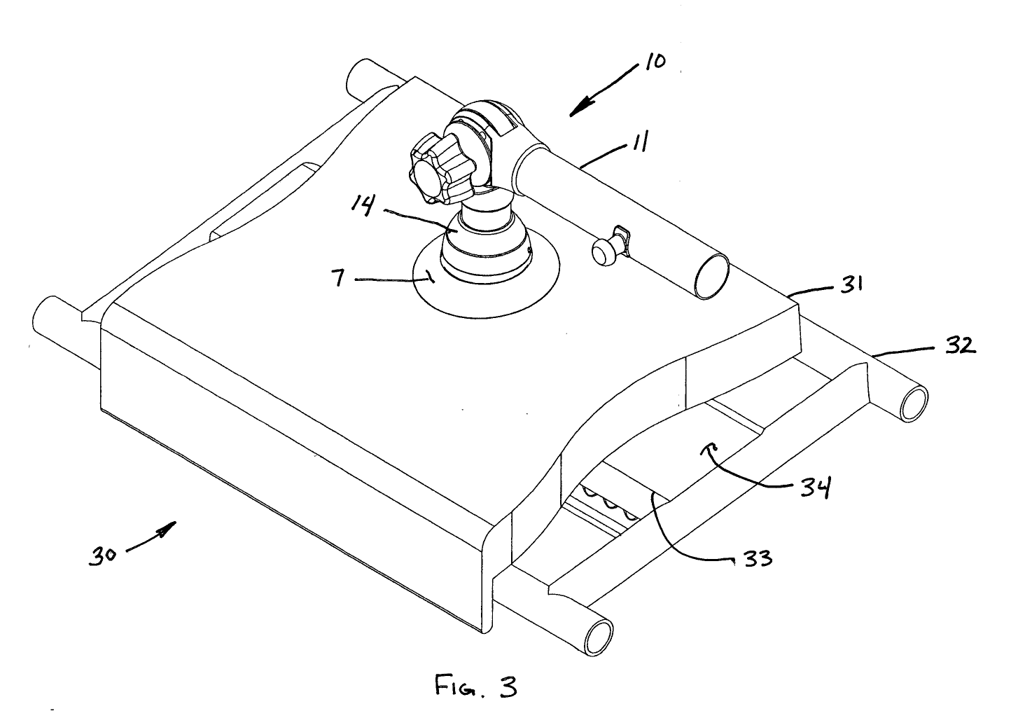

Referring now to the figures of the drawing in detail and first, particularly, to FIGS. 1a-3, which illustrate the outrigger assembly 10, the hardtop assembly 30 and the base plate adapter 1. The hardtop assembly 30 includes a hardtop 31, a frame 32 for mounting the hardtop 31 and a mounting plate 33 with a mounting surface 34. The mounting plate 33 is affixed to the frame 32 so that the mounting surface 34 faces the hardtop 31 on an underside of the hardtop 31. The hardtop 31 is usually provided with a slope α of anywhere between 0-15°. The slope may also be present on the frame 32 which in turn is present in the mounting surface 34 of the mounting plate 33, as the mounting plate 33 is mounted to the frame 32 by its ends. The hardtop 30 has a hole 35 formed therein for allowing the outrigger assembly 10 to pass through the hardtop 31. The mounting plate 33 has a hole 36 formed therein, which aligns with the hole 35 of the hardtop 31. The hole of the mounting plate 36 is of a smaller diameter than the hole 35 of the hardtop 31.

The outrigger assembly 10 includes a mounting arm 11 for mounting an outrigger (not shown). The outrigger assembly 10 also includes a rotator assembly 12, which is disposed below the hardtop 31 in the installed state thereof. The rotator assembly 12 includes a removable handle 13 for rotational adjustment of the position of the mounting arm 11. The outrigger assembly includes a sealing tube 14, which is located above the hardtop 31 in the installed state of the outrigger assembly 10 on the hardtop assembly 31.

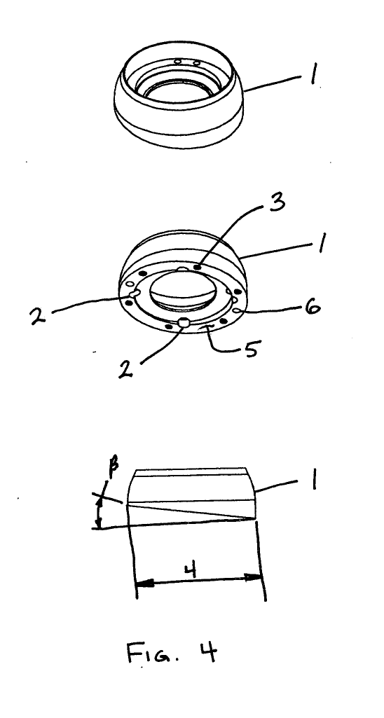

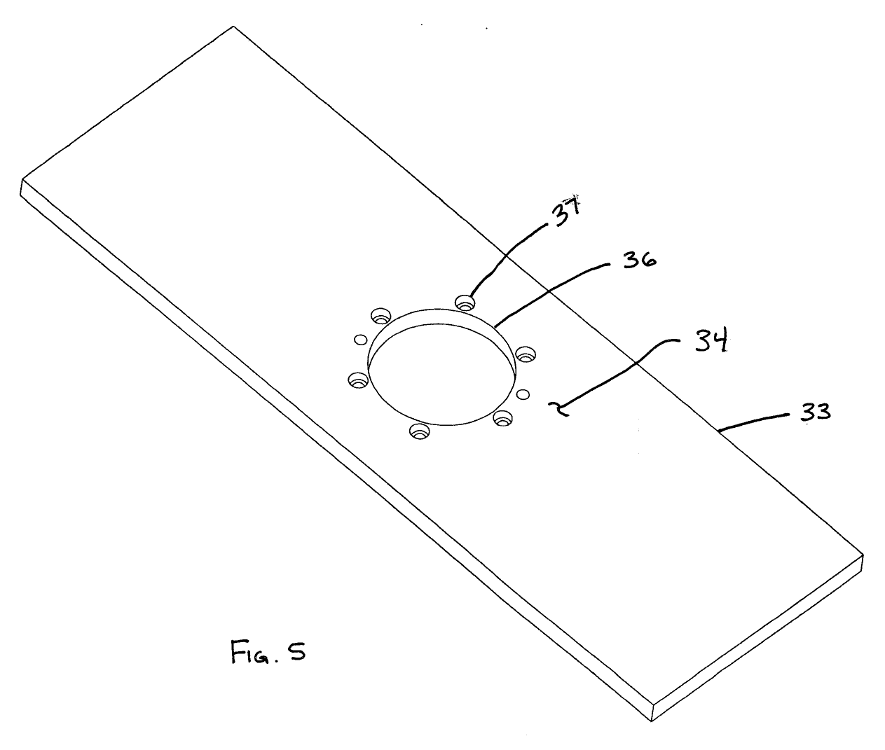

FIG. 4 shows the base plate adapter 1 in several views. The base plate adapter 1 is provided with a first hole pattern having counter bored holes 2. The counterbored holes 2 are provided for affixing the base plate adapter 1 to the outrigger assembly 10 in a region between the sealing tube 14 and the rotator assembly 12. This is only one configuration for affixing the base plate adapter 1 to the outrigger assembly 10. It is also possible for the base plate adapter 1 to be an integral part of one of the components of the outrigger assembly 1. Additional holes (not shown) may be provided in the base plate adapter 1 for receiving locating pins, which provide radial orientation of the base plate adapter 1 with respect to the outrigger assembly 10.

The base plate adapter 1 has a second hole pattern of threaded holes 3. The second hole pattern 3 is provided on a surface 5 of the base plate adapter 1, the surface 5 is created by a diameter 4, which defines a shoulder 5. The diameter 4 is of a size that will pass through the hole 35 in the hardtop 31 but which is large enough to not fit through the hole 36 formed in the mounting plate 33. This configuration allows the base plate adapter 1 to securely abut the top surface 34 of the mounting plate 33 with the surface 5. The surface 5 is provided with an angle β that compliments angle α of the mounting plate 33 for orienting the outrigger assembly 10 in a substantially vertical position. The range of the angle β is the same as for the angle α (0-15°). The mounting plate is provided with counterbored holes 37 corresponding to the second hole pattern 3. This allows fasteners 40 to secure the base plate adapter 1 from an underside of the mounting plate 33. Additionally, the base plate adapter can have a third hole pattern of locator holes 6 for receiving locating pins (41) which provide radial orientation of the base plate adapter 1 with respect to the mounting plate 33. This orientation is particularly useful for properly aligning the base plate adapter 1 with respect to the mounting plate when the angle β is greater than 0°. Alternatively, an irregular hole pattern for the holes 3 may be used, however, this has the disadvantage that the fasteners 40 must find the holes 3 to radially locate the base plate adapter while they are inserted from the underside of the hardtop 31. The base plate adapter 1 also has a seal 7 which seals the hole 35 provided in the hardtop 31, thereby preventing any water leakage through the hole 35.

The fact that the base plate adapter 1 has a diameter 4 which fits within the hole 35 of the hardtop 31 provides advantage that the hardtop 31 can be removed without removing the outrigger assembly 10.

The present invention serves to solve these particular installation issues and more, as the outrigger base mount does not use or rely on the flexible fiberglass hardtop material when mounting to the tower. Rather it mounts directly to the tower support mounting plate by installing through a pre-drilled hole in the hardtop that is large enough to allow a base-plate adapter to go through and not contact the fiberglass hardtop material.

Typically all bolt-in style outrigger base-mounts are fastened down from the top side of the tower with stainless-steel fasteners and washers and therefore because generally all bolt-in mounts have rectangular or square base-plates the outrigger base-mounts are not ideally suitable for mounting through a fiberglass hardtop because spacers ideally have to be used to prevent crushing of the material even if an aluminum support mounting plate or extruded profile is placed below the hardtop.

Further, typically the stainless-steel material fasteners used on top of the T-Top or hardtop to secure the bolt-in outrigger mounts, corrode due to exposure from salt-water and salt air. This becomes a problem because the dissimilar materials of the anodized aluminum base plates and stainless steel fasteners and washers are in such close contact with each other.

Another problem is the rectangular non-round bolt-in style outrigger base mounts are secured to the underside face of a support mounting plate, that is secured to the framework under the hardtop, the fasteners are in full view and the appearance is not very attractive and the thickness of the tower support mounting plate is positioned low relative to the top side of the tower, and thus closer to an occupant's head making safety an issue.

The other problem with this method of attachment to the tower plate is the upper arm of an outrigger base-mount is often lower by up to 3 inches than if it was mounted on top of the tower, which makes adjustment of the upper-arms adjusting/locking knobs harder to operate.

Another problem occurs when a bolt-in outrigger base-mount is installed directly to the tower support mounting plate. Then the fiberglass hardtop section is installed on top of the rectangular or square plated base-plate of the outrigger base-mount. But if the outrigger base-mount needs to be removed in the event of sale of the vessel, servicing or repair, then the entire fiberglass hardtop section must be removed at great expense and effort, just to be able to get the outrigger base mount off of the support mounting plate, as it was trapped between the tower support mounting plate and hardtop section.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. In combination with an outrigger assembly and a hardtop assembly having a hardtop with a hole formed therein for receiving the outrigger assembly and a mounting plate on an underside of the hardtop, the mounting plate having a hole corresponding to the hole in the hardtop, the outrigger assembly having a sealing tube disposed above the hardtop and a rotator assembly disposed below the hardtop, a base plate adapter for mounting the outrigger assembly to the hardtop assembly, the base plate adapter comprising:
a configuration attaching the base plate adapter to the outrigger assembly;
a diameter configured for passing through the hole formed in the hardtop, said diameter defining a shoulder having a surface configured for mating with the mounting plate, said shoulder having threaded holes formed therein configured for receiving threaded fasteners passing through the mounting plate thereby securing the outrigger assembly to the mounting plate.

2. The base plate adapter according to claim 1, wherein said surface has angle which compliments an angle of the mounting plate for aligning the outrigger assembly in a substantially vertical position.

3. The base plate adapter according to claim 2, further comprising locating pins disposed at said surface, said locating pins providing a radial location of the base plate adapter with respect to the mounting plate.

4. The base plate adapter according to claim 1, further comprising a seal configured to seal a gap between the sealing tube and the hardtop.

5. The base plate adapter according to claim 1, wherein said configuration includes counterbored holes for fastening the base plate adapter to the outrigger assembly.
